(19) United States
(12) Patent Application Publication
(10) Pub. No.: US 2016/0286730 A1
(43) Pub. Date: Oct. 6, 2016

(54) SUPPORT TRACK SYSTEM FOR LANDSCAPING MATERIALS

(71) Applicants: Tom Holsworth, Carmel, IN (US); Adam Strobel, Indianapolis, IN (US)

(72) Inventors: Tom Holsworth, Carmel, IN (US); Adam Strobel, Indianapolis, IN (US)

(21) Appl. No.: 15/086,318

(22) Filed: Mar. 31, 2016

Related U.S. Application Data
(60) Provisional application No. 62/140,949, filed on Mar. 31, 2015.

(51) Int. Cl. A01G 1/08

(52) U.S. Cl. CPC A01G 1/08

(57) ABSTRACT

A track system for supporting a landscaping material, the track system having a first track section including a first opening; a second track section positioned adjacent to the first track section, the second track section including a second opening; a connector for releasably securing the first track section to the second track section, the connector including a first end and a second end; and a fastener for securing the track system to a landscaping surface, wherein the first opening is configured to receive the first end of the connector and the second opening is configured to receive the second end of the connector.

### CROSS-REFERENCE TO RELATED APPLICATION

This application is related to and claims priority to U.S. Provisional Patent Application Ser. No. 62/140,949, which was filed on Mar. 31, 2015, the complete and entire disclosure of which is hereby expressly incorporated by reference herein.

### TECHNICAL FIELD

The present teachings are generally related to landscaping support track systems configured to stabilize landscaping materials (e.g., bricks, stones, rocks, etc.) on various surfaces, and more particularly to a plurality of track segments that are configured to be interlocked with one another to form a customized landscaping support track system.

### BACKGROUND OF THE DISCLOSURE

The statements in this section merely provide background information related to the present disclosure and should not be construed as constituting prior art.

Bricks and other landscaping materials are mostly employed in exterior designs for enhancing aesthetic appeal and diversifying outdoor layout arrangements. Bricks can be made of dried earth, concrete, stone, and various other materials, as such, they are often very heavy in weight.

When constructing a landscaping design, bricks are often stacked together or laid in horizontal courses. During the stacking process, conventional bricks tend to become uneven/unlevel, crooked, and unstable with respect to one another, thereby causing soil weight distribution issues, as well as structural and foundational problems. As a result, there is a desire and need in the landscaping and home improvement industry to provide a light-weight and durable structure that can be easily assembled, as well as safely provide a support surface that allows bricks and other landscaping materials to be installed in a stable and level manner.

The present application is intended to improve upon and resolve some of these known deficiencies in the art.

### SUMMARY OF THE DISCLOSURE

In accordance with one aspect herein, the present invention is configured to provide a landscaping support track system that is designed to ensure that bricks or other landscaping materials are installed in a stable, level and supported manner when placed on a landscaping surface, such as an embankment.

According to one specific embodiment, the landscaping support track system includes multiple track member sections that are interlocked with one another to form a desired shape. In accordance with this illustrative embodiment, and to create a landscaping support track system having the desired shape/length, multiple track member sections are interlocked with one another via cylindrical tubes that are located within flutes or channels of the interlocking track member sections. According to certain aspects herein, the interlocking track member sections are placed into the ground with fasteners, such as screws or spikes that protrude from the bottom surface of the interlocked track member sections. The fasteners are adapted to penetrate the ground and catch the soil deeply enough to provide traction and prevent the surrounding soil from uplifting the track system components or the landscaping materials, which could in turn cause the materials to experience an uneven and unstable orientation. After the track system is installed into the ground/soil, the landscaping materials (e.g., bricks, stones, rocks, etc.) are then placed on the support track system and held into place in a stabilized manner that thereby prevents the individual landscaping materials from moving or shifting with respect to one another.

According to one illustrative embodiment herein, a track system for supporting a landscaping material is provided. In accordance with this embodiment, the track system has a first track section that includes a first opening and a second track section that is positioned adjacent to the first track section and includes a second opening. The system also includes a connector for releasably securing the first track section to the second track section and a fastener for securing the track system to a landscaping surface. The connector includes a first end and a second end, wherein the first opening is configured to receive the first end and the second opening is configured to receive the second end.

In according to certain embodiments herein, the track system further comprises a flange that is formed by an edge of the first and second track sections, wherein the flange is configured to stabilize a landscaping material on a top surface of the first and second track sections.

According to another embodiment herein, the track system further comprises a third opening that is positioned on a top surface of at least one of the first and second track sections, wherein the third opening is configured to receive the fastener.

In accordance with still other embodiments, the track system further comprises a channel that is formed in a top surface of the first and second track sections. According to certain specific aspects herein, the channel is configured to have a width that is sized to securely receive a portion of a landscaping material, such as a portion of a brick, for instance.

In certain aspects of the present invention, the fastener of the track system is a threaded screw or spike that is configured to penetrate the landscaping surface.

In still other aspects of the present invention, the first opening of the first track section includes a corrugated flute that is positioned between the top and bottom surfaces of the first track section.

In yet other aspects of the present invention, the second opening of the second track section includes a corrugated flute that is positioned between the top and bottom surfaces of the second track section.

The first and second openings of the first and second track sections, in accordance with certain aspects of the present invention, are configured to align in such a manner that a common through hole is created for receiving the connector.

According to one embodiment of the present invention the track system comprises a first track section including an opening formed between a top surface and a bottom surface of the first track section; a second track section including a second opening formed between a top surface and a bottom surface of the second track section; a connector structurally bridging the first track section to the second track section in an adjacent manner, the connector including a first end and a second end; and a plurality of fasteners extending from at least one of the bottom surface of the first track section and the bottom surface of the second track section, the plurality of fasteners being configured to secure the track system to a landscaping surface.

According to certain aspects herein, the track system further comprises a flange formed by an edge of the first and second track sections, the flange being configured to stabilize a landscaping material on the top surfaces of the first and second track sections.

Other objects and benefits of the disclosure will become apparent from the following written description along with the accompanying figures.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure taken in conjunction with the accompanying drawings, wherein:

FIG. 1 is a perspective view of an assembled landscaping support track system in accordance with the teachings of the present disclosure.

FIG. 2 is a perspective view of an interlocking track member in accordance with the teachings of the present disclosure.

FIG. 3 is a side view of the interlocking track member of FIG. 2.

FIG. 4 is a sectional perspective view of a portion of an interlocking track member section having corrugated flutes in accordance with the teachings of the present disclosure.

FIG. 5 is a perspective view of a cylindrical tube for connecting adjacent interlocking track member sections in accordance with the teachings of the present disclosure.

FIG. 6 is perspective view of an assembled landscaping support track system having fasteners for securing the track system to a landscaping surface in accordance with one aspect of the present disclosure.

FIG. 7 is a perspective view of an interlocking track member section having a recess for receiving a fastener to secure the track member section to a landscaping surface in accordance with one aspect of the present disclosure.

FIG. 8 is a perspective view of an illustrative fastener that is configured to secure the support track system to a landscaping surface in accordance with one aspect of the present disclosure.

### DETAILED DESCRIPTION

The above-mentioned aspects of the present application and the manner of obtaining them will become more apparent and the teachings of the present application itself will be better understood by reference to the following description of the embodiments of the present application taken in conjunction with the accompanying drawings.

The embodiments of the present application described below are not intended to be exhaustive or to limit the teachings of the present application to the precise forms disclosed in the following detailed description. Rather, the embodiments are chosen and described so that others skilled in the art may appreciate and understand the principles and practices of the present application.

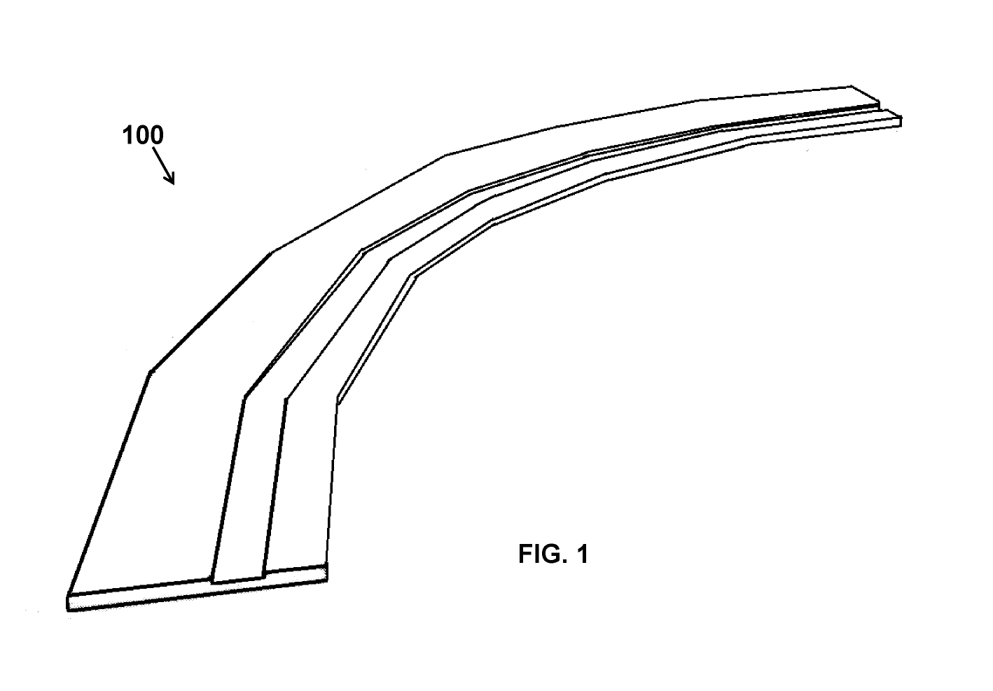

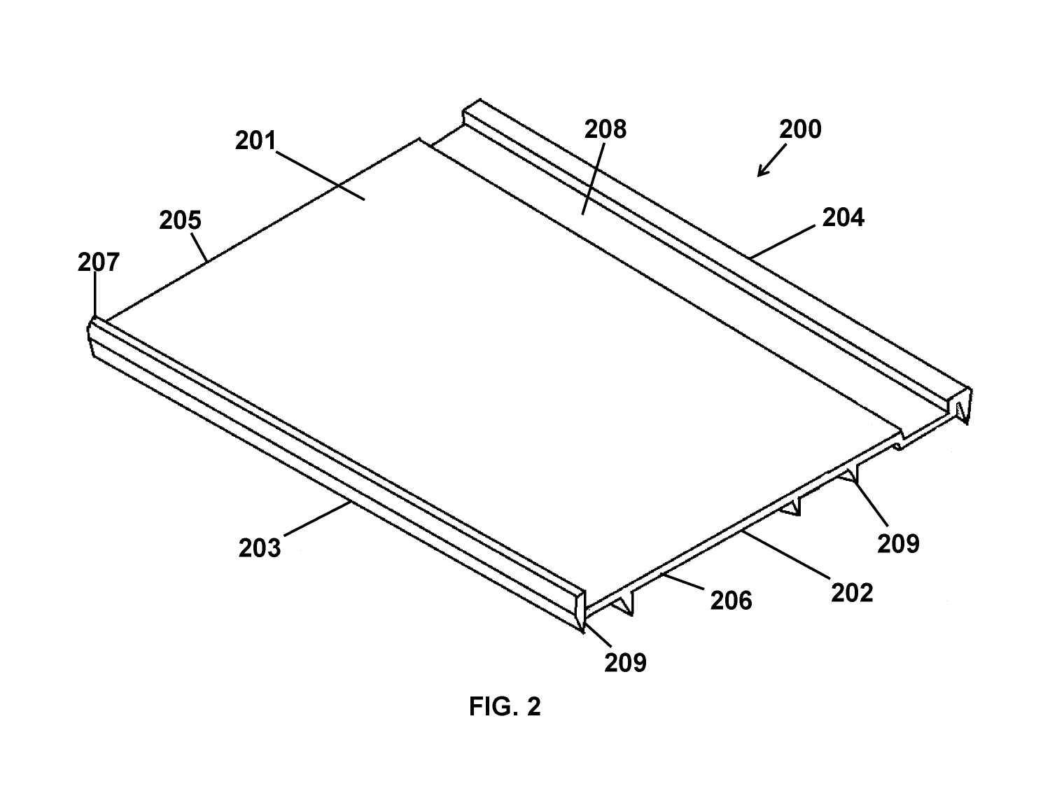

FIG. 1 illustrates a perspective view of an assembled landscaping support track system 100 designed to ensure that bricks, or other landscaping materials, stay stabilized, supported and level on a landscaping surface, such as an embankment. In accordance with this illustrative embodiment, the support track system 100 includes multiple interlocking track member sections 200 (shown in FIG. 2) of varying shapes and sizes to achieve a desired landscaping shape/length. It should be noted that while the assembled track system 100 shown in FIG. 1 does not show demarcations indicating where the individual track member sections 200 are interlocked, one of skill in the art will understand and appreciate that the system can be designed with individual sections of varying shapes/sizes in order to create a landscaping structure having a desired orientation. As such, the assembled system shown in FIG. 1 is provided for illustrative purposes only and is not intended to limit the scope of the present invention.

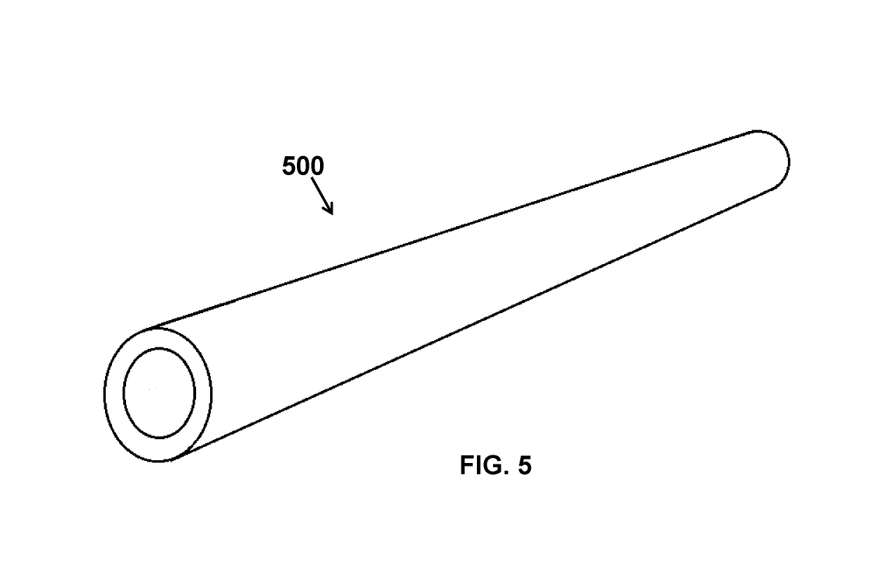

Moving now to FIG. 2, an illustrative rectangular interlocking track member section 200 used to form an assembled support track system 100 is shown. As will be explained in more detail below, in accordance with certain illustrative aspects herein, the interlocking track member sections 200 are connected to one another through a series of cylindrical tubes, such as tube 500 shown in FIG. 5. To this end, it should be understood and appreciated herein that the exact number and configuration of interlocking track member sections 200 used to design the support track system will largely depend on the particular shape and size of the area being landscaped. It should also be understood and appreciated herein that the support track system 100 may be configured to depict any number of landscaping shapes, such as, but not limited to, an oval-shaped support track system, a quad-oval-shaped support track system, an oval-shaped support track system having unequal ends, as well as numerous other shapes and configurations of tracks without departing from the scope or spirit of the present invention.

It should be understood and appreciated herein that while the interlocking track member sections 200 can have any geometric shape, in accordance with certain illustrative embodiments, the track members 200 are quadrilaterals, such as rectangles or trapezoids. In accordance with this illustrative aspect, the quadrilateral interlocking track member section 200 includes four sides, a top surface 201, a bottom surface 202, one longitudinal front lateral surface 203, one longitudinal rear lateral surface 204, and two parallel lateral surfaces 205, 206. The longitudinal front lateral surface 203 has a flange 207 at the edge to provide a safety barrier for ensuring that the bricks (or other such landscaping material) are held in place and maintained in a close, side-by-side relationship, thereby preventing and discouraging the bricks from moving and/or shifting with respect to one another.

The flange 207 can have varying heights and thicknesses along the longitudinal front lateral surface 203. In accordance with one embodiment, the height of the flange 207 is about 0.5 inches and the thickness is between about 0.0625 inches and about 0.3125. It should be noted that the flange's height and thickness may vary from one landscaping use to the next, whereby the present invention is not intended to be limited herein.

In accordance with certain aspects of the present invention, the top surface 201 may be smooth or textured and include one or more recesses or channels 208 extending lengthwise from one end of the rectangular interlocking track member section 200 to the opposite end. The length of the recess 208 extends from one parallel lateral surface 205 to the other parallel lateral surface 206. According to certain embodiments, the width of the recess 208 is configured to correspond with the width of the lip of a standard brick.

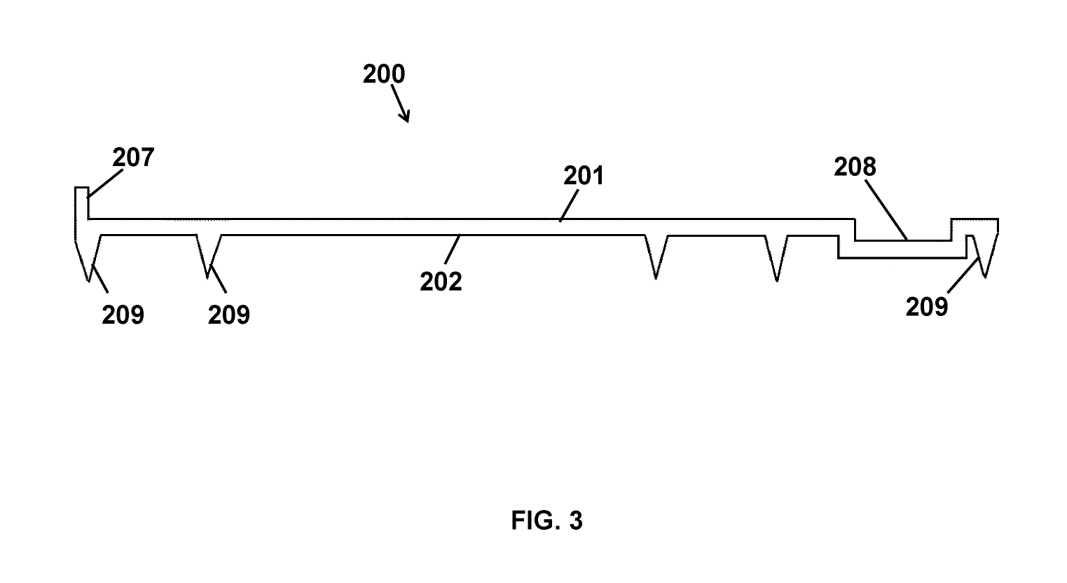

In accordance with certain embodiments herein, the bottom surface 202 of the track section member 200 comprises a plurality of protrusions 209 located along the length of the rectangular interlocking track member section 200 in order to offer support for stabilizing the track member section to a landscaping surface, such as the ground or a yard embankment. According to certain embodiments, one or more of the protrusions 209 may be located at the edge of the interlocking track member section 200 as part of the flange 207. In accordance with this embodiment, the other protrusions 209 can be spaced with respect to one another so as to provide the most support for securing the interlocking track member section 200 to the landscape installation surface. It should be noted that the interlocking track members of the present invention may comprise fewer or more protrusions 209 than what is depicted in the illustrative drawings and the examples provided herein, and that such arrangements are not intended to stray from the spirit or the scope of the present disclosure. In each embodiment, it should be understood and appreciated herein that the protrusions 209 are adapted to penetrate and catch the ground soil deeply enough to provide traction and thereby prevent the surrounding soil from uplifting the structure, thereby stabilizing the track system securely to the soil or landscape embankment. The protrusions 209 can also be seen in FIG. 3, which illustrates a side view of the interlocking track member section 200 of FIG. 2.

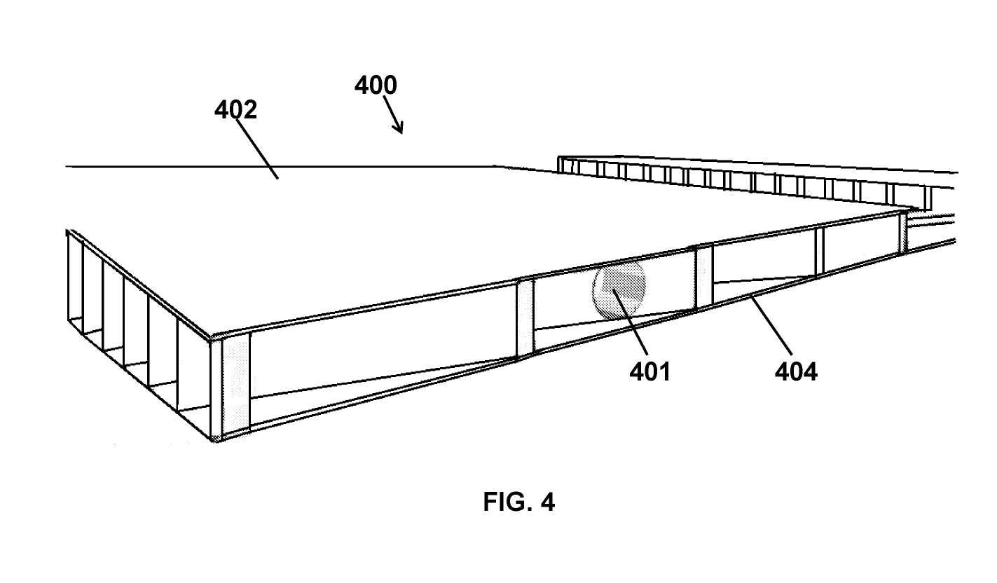

FIG. 4 illustrates a perspective view of another interlocking track member section 400 in accordance with the present invention. In accordance with this illustrative embodiment, the interlocking track member section 400 is fabricated from a corrugated plastic material, such as polyethylene, and has a thickness of about 10 mm. It should be noted, however, that the thickness and material used to fabricate the corrugated plastic sheet may vary as desired without straying from the spirit or the scope of the present disclosure. As such, those skilled in the art will recognize that numerous other materials and sizes are suitable for fabricating the interlocking track member sections of the present invention.

Still referring to FIG. 4, the track member section may include one or more corrugated flutes or channels 401 formed in between the top surface 402 and the bottom surface 404. It should be understood and appreciated herein that such an arrangement provides the structural strength and associated characteristics of plywood. In accordance with certain aspects, the corrugated interlocking track member section 400 may be manufactured from a lightweight, non-toxic, waterproof, shock proof, and corrosion preventive material designed to have a long life span.

FIG. 5 illustrates a cylindrical tube 500 used to connect the interlocking track member sections 400 together when installing a track system 100 in accordance with one aspect of the present invention. It should be understood and appreciated herein that while the cylindrical tube concept is shown with respect to the embodiment described within FIG. 4; those of skill in the art could also utilize the same or a similar installation process to interlock the track member sections of FIG. 2 as well (i.e., track member sections 200). As such, the present invention is not intended to be limited herein.

Still referring to FIG. 5, according to certain embodiments, the cylindrical tube 500 is fabricated from a plastic material and has a length of about four (4) inches. It should be noted that the cylindrical tube's material and length may vary as desired in accordance with different landscaping projects; whereby a person of skill in the art will understand that the invention is not intended to be limited herein.

In accordance with one embodiment, the exposed corrugated flutes 401 of the parallel lateral surfaces of the interlocking track members 400 are configured to receive the cylindrical tubes 500. The exposed flutes 401 are adapted to receive a cylindrical tube 500 inserted at least partially therein so that adjacent interlocking track member sections can be secured to one another during the installation process of the track system 100. Once all the desired interlocking track member sections 400 have been fastened to one another, an assembled support track system 100 can then be used to receive and stabilize landscaping materials placed thereon.

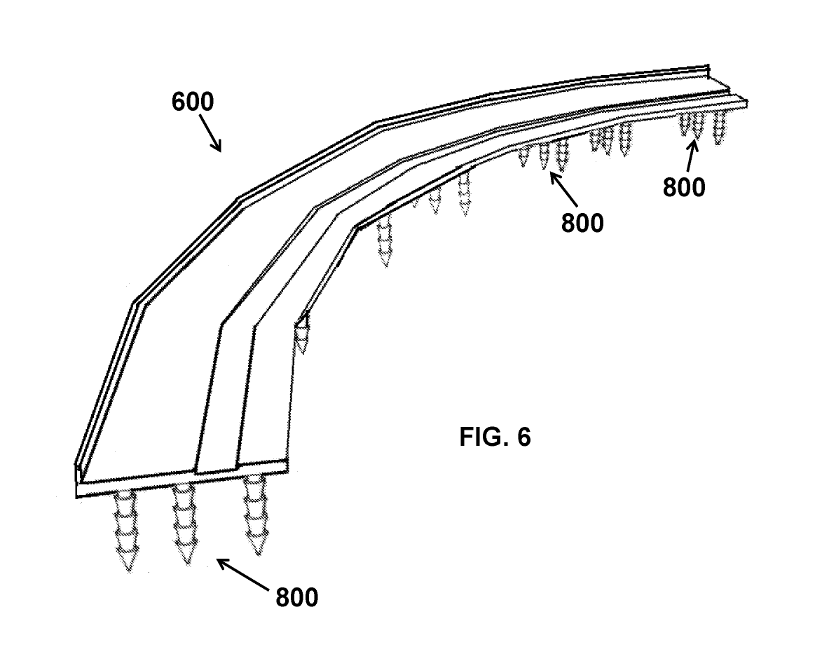

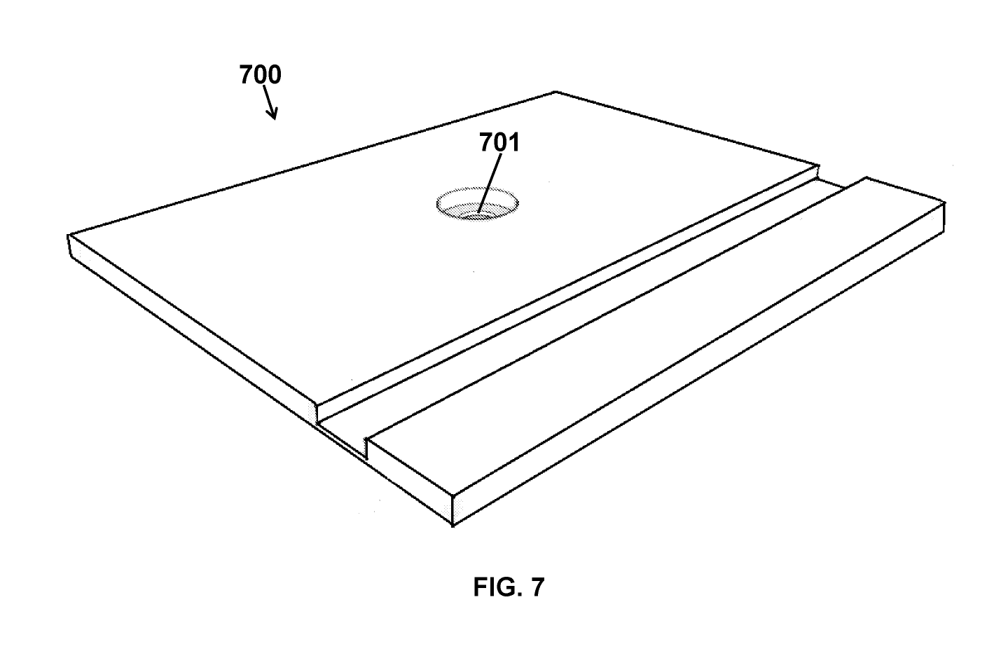

FIG. 6 illustrates a perspective view of another support track system 600 in accordance with one aspect of the present invention. According to this embodiment, the support track system 600 includes a plurality of fasteners 800, such as screws or spikes, for instance, which are configured to be inserted through an opening in the interlocking track member section to ensure the support track system 600 stays stabilized, supported, and level with respect to the landscaping surface to which it has been installed. For instance, and with specific reference to FIG. 7, a recess or opening 701 serves as a through hole between the top and bottom surfaces of the interlocking track member section 700 for receiving a fastener 800 as part of the track installation process. It should be understood and appreciated herein that while this illustrative embodiment shows only one recess, in accordance with other embodiments, a plurality of recesses may be fabricated into the interlocking track member sections to ensure that the entire system is adequately secured to the landscaping surface as desired.

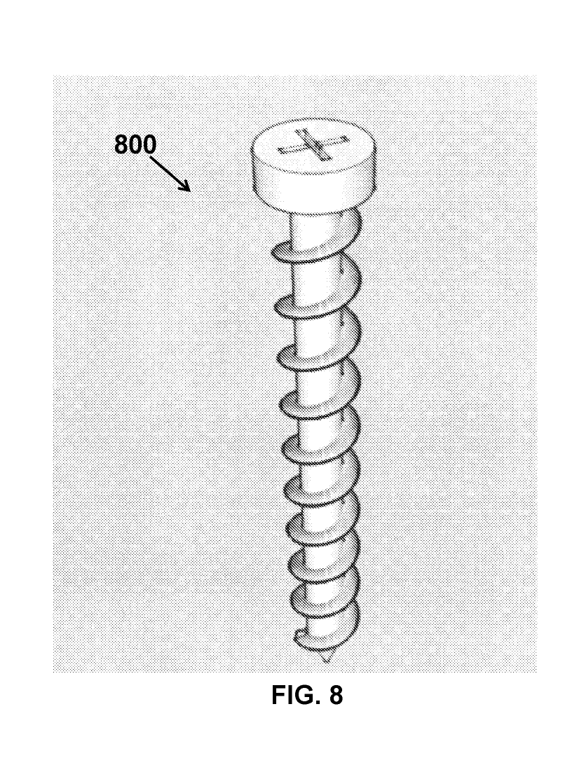

FIG. 8 depicts an illustrative fastener 800 in accordance with one aspect of the present invention. According to certain embodiments herein, the fastener 800 is fabricated from plastic, however, it should be understood herein that a person of skill in the art will recognize that numerous other materials may be used to fabricate the fastener without straying from the scope or teachings of the present invention.

While an exemplary embodiment incorporating the principles of the present application has been disclosed hereinabove, the present application is not limited to the disclosed embodiments. Instead, this application is intended to cover any variations, uses, or adaptations of the application using its general principles. Further, this application is intended to cover such departures from the present disclosure as come within known or customary practice in the art to which this present application pertains and which fall within the limits of the appended claims.

The terminology used herein is for the purpose of describing particular illustrative embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations).

1. A track system for supporting a landscaping material, the track system comprising:
a first track section including a first opening;
a second track section positioned adjacent to the first track section, the second track section including a second opening;
a connector for releasably securing the first track section to the second track section, the connector including a first end and a second end; and
a fastener for securing the track system to a landscaping surface;
wherein the first opening is configured to receive the first end of the connector and the second opening is configured to receive the second end of the connector.

2. The track system of claim 1, further comprising a flange formed by an edge of the first and second track sections, the flange being configured to stabilize a landscaping material on a top surface of the first and second track sections.

3. The track system of claim 1, further comprising a third opening positioned on a top surface of at least one of the first and second track sections, the third opening being configured to receive the fastener.

4. The track system of claim 1, further comprising a channel formed in a top surface of the first and second track sections.

5. The track system of claim 4, wherein the channel has a width sized to securely receive a portion of a landscaping material.

6. The track system of claim 5, wherein the channel is configured to securely receive a portion of a brick.

7. The track system of claim 1, wherein the fastener is a screw or spike configured to penetrate the landscaping surface.

8. The track system of claim 1, wherein the first opening includes a corrugated flute positioned between a top surface and a bottom surface of the first track section.

9. The track system of claim 8, wherein the second opening includes a corrugated flute positioned between a top surface and a bottom surface of the second track section.

10. The track system of claim 1, wherein the first and second openings are configured to align in such a manner that a common through hole is created for receiving the connector.

11. A track system for supporting a landscaping material, the track system comprising:
a first track section including an opening formed between a top surface and a bottom surface of the first track section;
a second track section including a second opening formed between a top surface and a bottom surface of the second track section;
a connector structurally bridging the first track section to the second track section in an adjacent manner, the connector including a first end and a second end; and
a plurality of fasteners extending from at least one of the bottom surface of the first track section and the bottom surface of the second track section, the plurality of fasteners being configured to secure the track system to a landscaping surface.

12. The track system of claim 11, further comprising a flange formed by an edge of the first and second track sections, the flange being configured to stabilize a landscaping material on the top surfaces of the first and second track sections.

13. The track system of claim 11, further comprising a third opening positioned on the top surface of at least one of the first and second track sections, the third opening being configured to receive at least one of the plurality of fasteners.

14. The track system of claim 11, further comprising a channel formed in the top surfaces of the first and second track sections.

15. The track system of claim 14, wherein the channel has a width sized to securely receive a portion of a landscaping material.

16. The track system of claim 15, wherein the channel is configured to securely receive a portion of a brick.

17. The track system of claim 11, wherein the fastener is a screw or spike configured to penetrate the landscaping surface.

18. The track system of claim 11, wherein the first opening includes a corrugated flute positioned between the top surface and a bottom surface of the first track section.

19. The track system of claim 18, wherein the second opening includes a corrugated flute positioned between the top surface and a bottom surface of the second track section.

20. The track system of claim 11, wherein the first and second openings are configured to align in such a manner that a common through hole is created for receiving the connector.
